(19) United States
(12) Patent Application Publication
(10) Pub. No.: US 2024/0333973 A1
(43) Pub. Date: Oct. 3, 2024

(54) ATLAS INFORMATION CARRIAGE IN CODED VOLUMETRIC CONTENT

(71) Applicant: GUANGDONG OPPO MOBILE TELECOMMUNICATIONS CORP., LTD., Dongguan (CN)

(72) Inventors: Vladyslav ZAKHARCHENKO, Palo Alto, CA (US); Yue YU, Palo Alto, CA (US)

(21) Appl. No.: 18/578,964

(22) PCT Filed: Mar. 22, 2022
(86) PCT No.: PCT/US2022/021407

§ 371 Date: Jan. 12, 2024

Related U.S. Application Data
(60) Provisional application No. 63/223,523, filed on Jul. 19, 2021.

(51) Int. Cl. H04N 19/597; H04N 19/129; H04N 19/176

(52) U.S. Cl. CPC H04N 19/597; H04N 19/129; H04N 19/176

(57) ABSTRACT

A system may include a demultiplexer, atlas component decoder, and an atlas pre-processing subsystem that includes a processor, and a non-transitory computer readable medium having encoded thereon a set of instructions executable by the processor to arrange one or more sub-bitstreams of a decoded atlas bitstream into one or more blocks, assign head information to each block, and generate a block-order decoded atlas bitstream, wherein generating the block-order decoded atlas bitstream includes ordering the one or more blocks of the decoded atlas bitstream in a scan order following a space-filling curve.

### CROSS-REFERENCE TO RELATED APPLICATION

This application claims the benefit of U.S. Provisional Application No. 63/223,523, filed Jul. 19, 2021, entitled METHOD AND APPARATUS FOR ATLAS INFORMATION CARRIAGE IN VOLUMETRIC CONTENT, the contents of which are hereby incorporated by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for volumetric video coding for three-dimensional data.

### BACKGROUND

Dynamic point clouds are a time series of points located in 3-dimensional (3D) space, encapsulated by a bounding box, where each of the points are, respectively, associated with one or more attributes, such as color, reflectance, transparency, material type, normal, etc. A coded point cloud frame is a collection of 3D segments, called patches, which are 3D segment projections onto 2-dimensional (2D) planes (e.g., occupancy, geometry, and attribute) with corresponding atlas information (raw byte stream) that specifies an inverse projection process from 2D to 3D space.

Atlas information for a point cloud frame, referred to herein as “atlas frame information,” when decoded, is specified as a raw byte sequence associated and arranged in a hierarchical format. The size of a decoded atlas frame varies depending on the segmentation and projection processes of the point cloud frame, leading to inefficient processing and buffer management.

Thus, a framework for atlas information carriage in volumetric content is provided.

### SUMMARY

Tools and techniques for the carriage and provisioning of atlas information in volumetric content are provided.

A method includes obtaining immersive media data comprising encoded data for three-dimensional volumetric media content, extracting, via a media pipeline, component data, the component data comprising an atlas component, attribute component, geometry component, and occupancy component, and decoding, via an atlas component decoder, the atlas component, wherein a decoded atlas component is output as decoded atlas bitstream. The method further includes assembling an atlas frame in block-order based on the decoded atlas bitstream. Assembling the atlas frame in block-order further includes arranging, via the atlas pre-processing logic, one or more sub-bitstreams of the decoded atlas bitstream into one or more blocks, respectively, assigning, via the pre-processing logic, header information to each block of the one or more blocks, the header information indicating respective tile information for each block, and generating, via the atlas pre-processing logic, a block-order decoded atlas bitstream. Generating the block-order decoded atlas bitstream includes ordering, via the atlas pre-processing logic, the one or more blocks of the decoded atlas bitstream in a scan order following a space-filling curve. The method further includes providing, via the atlas pre-processing logic, the block-order decoded atlas bitstream to an input buffer of a presentation engine, wherein the input buffer is configured to provide the block-order atlas bitstream to the presentation engine.

An apparatus includes a non-transitory computer readable medium in communication with the processor, the non-transitory computer readable medium having encoded thereon a set of instructions executable by the processor to perform various functions. The set of instructions may be executed by the processor to obtain an immersive media data comprising encoded data for three-dimensional volumetric media content, extract, via a media pipeline, component data, the component data comprising an atlas component, attribute component, geometry component, and occupancy component, and decode, via an atlas component decoder, the atlas component, wherein a decoded atlas component is output as decoded atlas bitstream. The set of instructions may further be executed by the processor to assemble an atlas frame in block-order based on the decoded atlas bitstream. Assembling the atlas frame in block-order may include arranging, via the atlas pre-processing logic, one or more sub-bitstreams of the decoded atlas bitstream into one or more blocks, respectively, assigning, via the pre-processing logic, header information to each block of the one or more blocks, the header information indicating respective tile information for each block, and generating, via the atlas pre-processing logic, a block-order decoded atlas bitstream. Generating the block-order decoded atlas bitstream includes ordering, via the atlas pre-processing logic, the one or more blocks of the decoded atlas bitstream in a scan order following a space-filling curve. The set of instructions may further be executed by the processor to provide, via the atlas pre-processing logic, the block-order decoded atlas bitstream to an input buffer of a presentation engine, wherein the input buffer is configured to provide the block-order atlas bitstream to the presentation engine.

A system may include a demultiplexer configured to demultiplex immersive media data, wherein immersive media data comprises encoded data for three-dimensional volumetric media content, wherein demultiplexing the immersive media data includes extracting an atlas component, an atlas component decoder coupled to the demultiplexer, the atlas component decoder configured to decode the atlas component, wherein a decoded atlas component is output as decoded atlas bitstream, and an atlas pre-processing subsystem coupled to the atlas component decoder. The atlas pre-processing subsystem may further include a processor, and a non-transitory computer readable medium in communication with the processor, the non-transitory computer readable medium having encoded thereon a set of instructions executable by the processor to arrange one or more sub-bitstreams of the decoded atlas bitstream into one or more blocks, assign header information to each block of the one or more blocks, the header information indicating respective tile information for each block, and generate a block-order decoded atlas bitstream. Generating the block-order decoded atlas bitstream includes ordering the one or more blocks of the decoded atlas bitstream in a scan order following a space-filling curve.

These illustrative embodiments are mentioned not to limit or define the disclosure, but to provide examples to aid understanding thereof. Additional embodiments are discussed in the Detailed Description, and further description is provided therein.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic block diagram of a system for media access pipeline synchronization and buffer management, in accordance with various embodiments;

FIG. 2 is a schematic diagram of an atlas frame, in accordance with various embodiments;

FIG. 3 is a schematic diagram illustrating a block-order decoded atlas bitstream, in accordance with various embodiments;

FIG. 4 is a flow diagram of a method for provisioning decoded atlas information associated with volumetric content, in accordance with various embodiments;

FIG. 5 is a schematic block diagram of a computer system for provisioning decoded atlas information associated with volumetric content, in accordance with various embodiments.

### DETAILED DESCRIPTION OF EMBODIMENTS

Various embodiments provide tools and techniques for the carriage and provisioning of atlas information in volumetric content.

In some embodiments, a method for providing atlas information in volumetric content is provided. A method includes obtaining immersive media data comprising encoded data for three-dimensional volumetric media content, extracting, via a media pipeline, component data, the component data comprising an atlas component, attribute component, geometry component, and occupancy component, and decoding, via an atlas component decoder, the atlas component, wherein a decoded atlas component is output as decoded atlas bitstream. The method further includes assembling an atlas frame in block-order based on the decoded atlas bitstream. Assembling the atlas frame in block-order further includes arranging, via the atlas pre-processing logic, one or more sub-bitstreams of the decoded atlas bitstream into one or more blocks, respectively, assigning, via the pre-processing logic, header information to each block of the one or more blocks, the header information indicating respective tile information for each block, and generating, via the atlas pre-processing logic, a block-order decoded atlas bitstream. Generating the block-order decoded atlas bitstream includes ordering, via the atlas pre-processing logic, the one or more blocks of the decoded atlas bitstream in a scan order following a space-filling curve. The method further includes providing, via the atlas pre-processing logic, the block-order decoded atlas bitstream to an input buffer of a presentation engine, wherein the input buffer is configured to provide the block-order atlas bitstream to the presentation engine.

In some examples, the method may further include obtaining, via atlas pre-processing logic, the decoded atlas bitstream from the atlas component decoder, wherein the decoded atlas information is provided by the atlas component decoder in a patch-order. In some embodiments, the one or more blocks of the block-order decoded atlas bitstream are ordered in raster scan order of an atlas tile of the atlas frame.

In some examples, the header information may include a patch identifier and block identifier of each block, the patch identifier identifying a patch to which a respective block belongs, and the block identifier identifying a position of the respective block within the patch. In further examples, the respective tile information may include one or more of a tile index, tile identifier, tile origin, and tile size for a respective block. In some examples, the header information may include a tile identifier and patch identifier. In further examples, the header information may include one or more of an atlas frame delimiter, atlas tile delimiter, and patch delimiter.

In further examples, the decoded atlas bitstream comprises an atlas frame size indicator followed by an atlas frame payload, wherein the atlas frame payload comprises one or more tile size indicators, each tile size indicator followed by a respective tile payload, and each respective tile payload comprises one or more patch size indicators, each patch size indicator followed by a respective patch payload, wherein the patch payload comprises a plurality of blocks in a raster scan order.

In some embodiments, an apparatus for atlas information carriage in volumetric content is provided. An apparatus includes a non-transitory computer readable medium in communication with the processor, the non-transitory computer readable medium having encoded thereon a set of instructions executable by the processor to perform various functions. The set of instructions may be executed by the processor to obtain an immersive media data comprising encoded data for three-dimensional volumetric media content, extract, via a media pipeline, component data, the component data comprising an atlas component, attribute component, geometry component, and occupancy component, and decode, via an atlas component decoder, the atlas component, wherein a decoded atlas component is output as decoded atlas bitstream. The set of instructions may further be executed by the processor to assemble an atlas frame in block-order based on the decoded atlas bitstream. Assembling the atlas frame in block-order may include arranging, via the atlas pre-processing logic, one or more sub-bitstreams of the decoded atlas bitstream into one or more blocks, respectively, assigning, via the pre-processing logic, header information to each block of the one or more blocks, the header information indicating respective tile information for each block, and generating, via the atlas pre-processing logic, a block-order decoded atlas bitstream. Generating the block-order decoded atlas bitstream includes ordering, via the atlas pre-processing logic, the one or more blocks of the decoded atlas bitstream in a scan order following a space-filling curve. The set of instructions may further be executed by the processor to provide, via the atlas pre-processing logic, the block-order decoded atlas bitstream to an input buffer of a presentation engine, wherein the input buffer is configured to provide the block-order atlas bitstream to the presentation engine.

In some examples, the set of instructions may further be executable by the processor to obtain, via atlas pre-processing logic, the decoded atlas bitstream from the atlas component decoder, wherein the decoded atlas information is provided by the atlas component decoder in a patch-order. In some examples, the one or more blocks of the block-order decoded atlas bitstream are ordered in raster scan order of an atlas tile of the atlas frame.

In some examples, the header information may include a patch identifier and block identifier of each block, the patch identifier identifying a patch to which a respective block belongs, and the block identifier identifying a position of the respective block within the patch. In further examples, the respective tile information may include one or more of a tile index, tile identifier, tile origin, and tile size for a respective block. In some examples, the header information may include a tile identifier and patch identifier. In further examples, the header information may include one or more of an atlas frame delimiter, atlas tile delimiter, and patch delimiter.

In further examples, the decoded atlas bitstream comprises an atlas frame size indicator followed by an atlas frame payload, wherein the atlas frame payload comprises one or more tile size indicators, each tile size indicator followed by a respective tile payload, and each respective tile payload comprises one or more patch size indicators, each patch size indicator followed by a respective patch payload, wherein the patch payload comprises a plurality of blocks in a raster scan order.

In in further embodiments, a system for atlas information carriage in volumetric content is provided. A system may include a demultiplexer configured to demultiplex immersive media data, wherein demultiplexing the immersive media data includes extracting an atlas component, an atlas component decoder coupled to the demultiplexer, the atlas component decoder configured to decode the atlas component, wherein a decoded atlas component is output as decoded atlas bitstream, and an atlas pre-processing subsystem coupled to the atlas component decoder. The atlas pre-processing subsystem may further include a processor, and a non-transitory computer readable medium in communication with the processor, the non-transitory computer readable medium having encoded thereon a set of instructions executable by the processor to arrange one or more sub-bitstreams of the decoded atlas bitstream into one or more blocks, assign header information to each block of the one or more blocks, the header information indicating respective tile information for each block, and generate a block-order decoded atlas bitstream. Generating the block-order decoded atlas bitstream includes ordering, the one or more blocks of the decoded atlas bitstream in a scan order following a space-filling curve.

In some examples, the header information may include a patch identifier and block identifier of each block, the patch identifier identifying a patch to which a respective block belongs, and the block identifier identifying a position of the respective block within the patch. In further examples, the respective tile information may include one or more of a tile index, tile identifier, tile origin, and tile size for a respective block. In some examples, the header information may include a tile identifier and patch identifier. In further examples, the header information may include one or more of an atlas frame delimiter, atlas tile delimiter, and patch delimiter.

In the following description, for the purposes of explanation, numerous details are set forth to provide a thorough understanding of the described embodiments. It will be apparent to one skilled in the art, however, that other embodiments may be practiced without some of these details. In other instances, structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, apparatuses, and/or software products. Merely by way of example, a method might comprise one or more procedures, any or all of which may be executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

Various embodiments described herein, embodying software products and computer-performed methods, represent tangible, concrete improvements to existing technological areas, including, without limitation, the decoding and rendering of volumetric content (e.g., 3D immersive media data), such as, without limitation visual volumetric video-based coding data.

Specifically, implementations of various embodiments provide for a way to code (e.g., encode and decode) atlas information in association with volumetric content. Specifically, a framework is proposed making use of an atlas information format with features for efficient decoding, processing (e.g., information derivation), and storage.

Thus, the framework for provisioning decoded atlas information in association with volumetric content, set forth below, allows for an efficient solution to implementing atlas information carriage in association with volumetric content.

To the extent any abstract concepts are present in the various embodiments, those concepts can be implemented as described herein by devices, software, systems, and methods that involve novel functionality (e.g., steps or operations), such as the media access pipeline, atlas component decoder, atlas component pre-processing subsystem(s) and logic, input buffers, and a presentation engine, among other components of the media access pipeline.

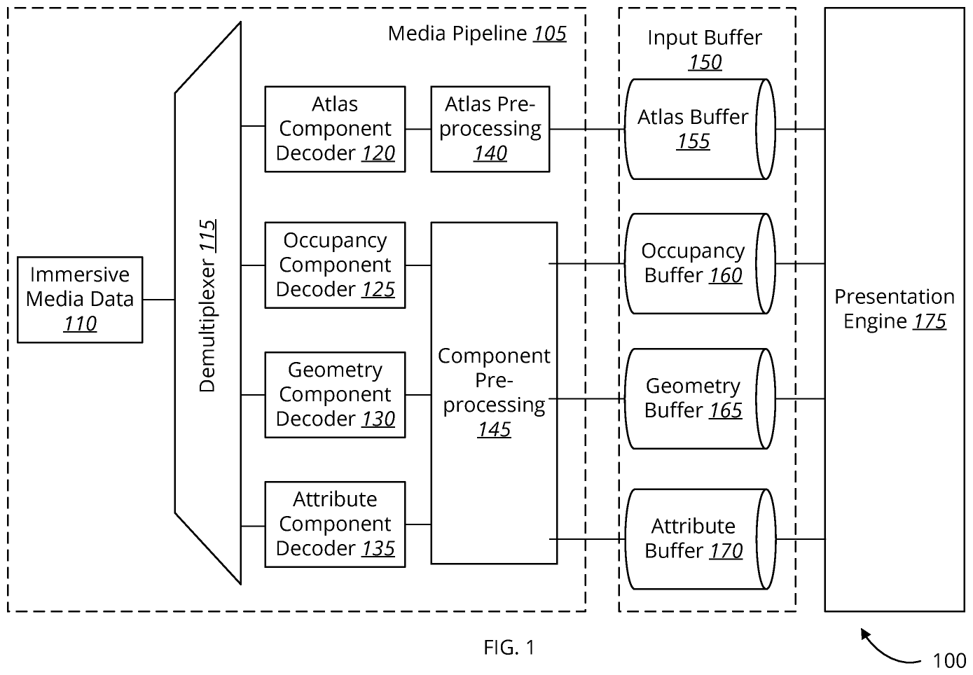

FIG. 1 is a schematic block diagram of a system 100 for a media access pipeline synchronization and buffer management, in accordance with various embodiments. The system 100 includes media pipeline 105, immersive media data 110, demultiplexer 115, atlas component decoder 120, occupancy component decoder 125, geometry component decoder 130, attribute component decoder 135, atlas pre-processing 140, component pre-processing 145, input buffer 150, atlas buffer 155, occupancy buffer 160, geometry buffer 165, attribute buffer 170, and presentation engine 175. It should be noted that the various components of the system 100 are schematically illustrated in FIG. 1, and that modifications to the various components and other arrangements of system 100 may be possible and in accordance with the various embodiments.

In various embodiments, the media pipeline 105 may include immersive media data 110, demultiplexer 115, atlas component decoder 120, occupancy component decoder 125, geometry component decoder 130, attribute component decoder 135, atlas pre-processing 140, and component pre-processing 145. The demultiplexer 115 may receive immersive media data 110, and may further demultiplex the immersive media data 110 to produce media components, which may include an atlas component, occupancy component, geometry component, and attribute component. Thus, the outputs of the demultiplexer 115 may be coupled, respectively, to atlas component decoder 120, occupancy component decoder 125, geometry component decoder 130, and attribute component decoder 135. The atlas component decoder 120 may be coupled to the atlas pre-processing 140, and the occupancy, geometry, and attribute component decoders 125, 130, 135 may be coupled to the component pre-processing 145. The atlas pre-processing 140 and component pre-processing 145 may be coupled to input buffer 150. Input buffer 150 may include atlas buffer 155, occupancy buffer 160, geometry buffer 165, and attribute buffer 170. The output of the atlas pre-processing 140 may be coupled to the atlas buffer 155. The output of the component pre-processing 145 may be coupled to the occupancy, geometry, and attribute buffers 160, 165, 170. Each of the buffers 155, 160, 165, 170 of the input buffer 150 may be coupled to the presentation engine 175.

In various embodiments, the immersive media data 110 may include volumetric content, such as 3D encoded media data. In some examples, the immersive media data 110 may include, for example, that is formatted visual volumetric video-based coding (V3C) data. The immersive media data 110 may be a single track comprising one or more volumetric (e.g., 3D) frames of volumetric media data. In some embodiments, the immersive media data may be an encoded bitstream representing the one or more volumetric frames. For example, the immersive media data 110 may include one or more components (e.g., V3C components). For examples, the immersive media data 110 may include occupancy, geometry, and attribute components, which may respectively represent properties for each point of a volumetric frame, and an atlas component.

In various embodiments, the atlas component may include an atlas, which may further comprise one or more atlas frames. The atlas may be a collection of 2D bounding boxes and associated information (e.g., patches) for reconstructing a 3D point cloud from respective 2D projections. In some examples, the atlas may be a bitstream that forms the one or more atlas frames of the atlas. The atlas frame may be a 2D array of atlas samples onto which patches may be projected. Thus, a patch may refer to a rectangular region within an atlas associated with volumetric information. In some examples, a patch may correspond to a segment or a bounding box of a 3D object (or part of an object) in a volumetric frame. Each atlas frame may be a collection of atlas tiles, where each tile may be identified by a unique tile index (e.g., tileID). In some examples, each atlas tile may be an independently decodable region of an atlas frame. Each atlas tile may further include an array of patches, where each patch may be identified by a unique patch index, or patchID.

In some examples, an atlas frame may correspond to a 3D frame of the immersive media data 110, which may include 3D volumetric content. Patches may include atlas information (e.g., patch data) to convert from the 2D projections back into 3D space. The patches themselves may correspond to segments of a 3D object (e.g., bounding boxes) of the 3D frame that have been projected in 2D. Thus, in various embodiments, the number of patches, and the sizes of respective patches may vary across different atlas frames. Thus, the size of an atlas frame may vary from frame to frame, depending on the segmentation and projection processes. This is in contrast with image information, which has a known size and resolution. Thus, occupancy, geometry, and attribute components of a given frame may have a given size and resolution.

In various embodiments, the occupancy component may include one or more occupancy frames (or occupancy map), which are 2D arrays of occupancy information, and constitute occupancy information of the patches of a respective atlas frame. Occupancy information, for example, includes information indicating whether an atlas sample corresponds to a sample in 3D space. A geometry component may include one or more geometry frames (or geometry map), which are a 2D array of geometry information associated with the patches of a respective atlas frame. The geometry information may, in some examples, be a set of Cartesian coordinates associated with a volumetric frame. Similarly, the attribute component may include one or more attribute frames (or attribute map), which are 2D arrays of attribute information associated with patches of a respective atlas frame. In some examples, the immersive media data 110 may include one or more attribute components, each attribute component representing a respective scalar or vector property of each point in the volumetric frame. Attributes, for example, may include, without limitation, color, reflectance, surface normal, transparency, material identification (ID), etc.

In various embodiments, the demultiplexer 115 may be configured to separate the immersive media data 110 into its components (e.g., atlas component, occupancy component, geometry component, and attribute component). In some examples, the demultiplexer 115 may be configured to separate the immersive media data 110 into its component bitstreams, and further into its one or more sub-bitstreams. In various embodiments, the immersive media data 110 may be a coded bitstream. Accordingly, each of the component bitstreams may respectively be coded. Each of the coded component bitstreams may be fed to respective decoders. For example, a component bitstream corresponding to the atlas component may be fed, via the demultiplexer 115, to the atlas component decoder 120. Similarly, a component bitstream corresponding to the occupancy component, geometry component, and attribute component may be provided, via the demultiplexer 115, to the occupancy component decoder 125, geometry component decoder 130, and attribute component decoder 135, respectively.

In various embodiments, the atlas component decoder 120 may be configured to decode the encoded atlas component, which may, in some examples, be an encoded bitstream. In some embodiments, the atlas component decoder 120 may include a set of atlas network abstraction layer units associated with each other, in consecutive decoding order, for a given point in time (e.g., a 3D frame). A network abstraction layer unit may be configured to indicate the type of data to follow and bytes containing that data in the form of a raw byte sequence payload. Thus, the output of the atlas component decoder 120 may be a raw byte sequence comprising the atlas information. Similarly, the occupancy component decoder 125, geometry component decoder 130, and attribute component decoder 135 may include respective sets of network abstraction layer units configured to decode the respective coded occupancy, geometry, and attribute component bitstreams. In some examples, the outputs of the occupancy, geometry, and attribute component decoders 125, 130, 135 may be considered 2D projection images.

In various embodiments, the outputs of the respective decoders 120, 125, 130, 135 may be further processed via respective pre-processing logic. For example, the output of the atlas component decoder 120 may be coupled to atlas pre-processing 140, for further processing. Similarly, the outputs of the occupancy, geometry, and attribute decoders 125, 130, 135 may be coupled to component pre-processing 145. Accordingly, in various embodiments, atlas pre-processing 140 and component pre-processing 145 may include respective logic for processing of the decoded component information. Atlas pre-processing 140 and component pre-processing 145 may include software, hardware, or both hardware and software.

As previously described, in conventional arrangements, the atlas component of the immersive media data 110 may be decoded and transmitted to an input buffer of the presentation engine 175 directly. The format of the output of the atlas component decoder 120 being native byte stream, there is no clear identification distinguishing the elements within the decode atlas bitstream. For example, within each atlas tile, the location of each patch in the 2D projection may be defined by patch origin and patch size. A patch scanning order does not depend on patch location in the projection image, or patch index. Rather, the patch is an array of blocks organized in a raster scan order. A patch block (or simply “block”) is defined as a minimal coding element. The size of the block is defined by packing block size and occupancy map resolution. The system assumes that the input to the presentation engine 175 is managed by the circular buffer (e.g., input buffer). Thus, considering that size of the decoded atlas frame vary it is impossible to use circular buffer efficiently.

The system 100, therefore, includes atlas pre-processing 140 to process the the decoded bytestream output of the atlas component decoder 120, before transmitting to the atlas buffer 155. Thus, atlas pre-processing 140 may be configured to provide a bytestream in a format that can be natively understood by the presentation engine 175. In some examples, the atlas pre-processing 140 may be configured to output a decoded atlas bitstream in a format that creates a fixed size for each decoded atlas frame, which further eases memory management and provide an efficient way for random access of a patch, and partial reconstruction within the media pipeline 105 and presentation engine 175.

Specifically, the atlas pre-processing 140 may be configured to output block list information (e.g., a series of blocks) to the block buffer 155 according to a space-filling curve over the entire tile, as opposed to a raster scan order on a per-patch (e.g., patch-order) basis. In various embodiments, the space-filling curve may define a scan order that covers, in this example, each block of the entire tile. Accordingly, the space-filling curve may include, without limitation, a Z-order curve (e.g., a curve that follows a raster scan order), other curve that follows a mathematical and/or other regular pattern (e.g., Gosper curve, Dragon curve, Hilbert Curve, etc.), and irregular pattern, or a custom user-defined curve. In various embodiments, each block in the decoded atlas frame may provide information required for 3-dimensional image reconstruction. The atlas pre-processing 140 may be configured to format the decoded atlas frame as a collection of blocks arranged in a raster scan order for the associated tiles in the image. Header information for an output file can optionally transfer the tile information, such as tileID, tile origin (coordinates of the top-left most point of the tile projection), and tile size (tile width and height). Alternatively, tileID and patchID may be directly transmitted per each block.

A block may, accordingly, be defined as follows. In some examples, occupancy map information may be repeated for each block. An occupancy map 2D array (e.g., an occupancy frame at a given depth) may be represented in a row-major raster scan order. Each entry in the occupancy array may be 1 bit value. Thus, a 4×4 array may be represented as a 16-bit value. In some further examples, in the case of occupancy maps of 2×2 or 1×1 array sizes, the occupancy maps may be subsampled to a total of 16 bits. For example, a 2×2 array may be represented as 4 records of 4 bits, for a total of 16 bits.

Similarly, associated patch information may also be transmitted for each block. Patch projection information may comprise 12 bits+4 bits trailing, for a total of 16 bits. Patch projection information may include a patch tangent axis index (2 bits), a patch bitangent axis index (2 bits), and a patch normal axis index (2 bits). For example, “00” may indicate the x-axis, “01” may indicate the y-axis, and “10” may indicate the z-axis. “11” may be restricted. A TilePatchProjectionFlag (1 bit) may be set to indicate a forward projection direction “0” or a backward projection direction “1.” In some examples, patch projection information may further include TilePatch45Degree Mode (2 bits), which may be used to indicate a 45-degree projection. For example, no 45-degree projection may be represented as “00,” x-axis 45-degree projection “01,” y-axis 45-degree projection as “10,” and z-axis 45-degree projection as “11.” Patch projection information may further include a patch projection orientation (rotation) index (3 bits), and trailing bits (4 bits) reserved for buffer alignment.

Each block may further include a patch 3D shift tangential per block (16 bits), which indicates a shift (e.g., a magnitude/scalar value of a shift) of the patch (e.g., a patch origin) in the x-axis direction. Similarly, the block may further include a patch 3D shift bitangential per block (16 bits) (e.g., a shift in the y-axis direction), and a patch 3D shift normal per block (16 bits) (e.g., a shift in the z-axis direction).

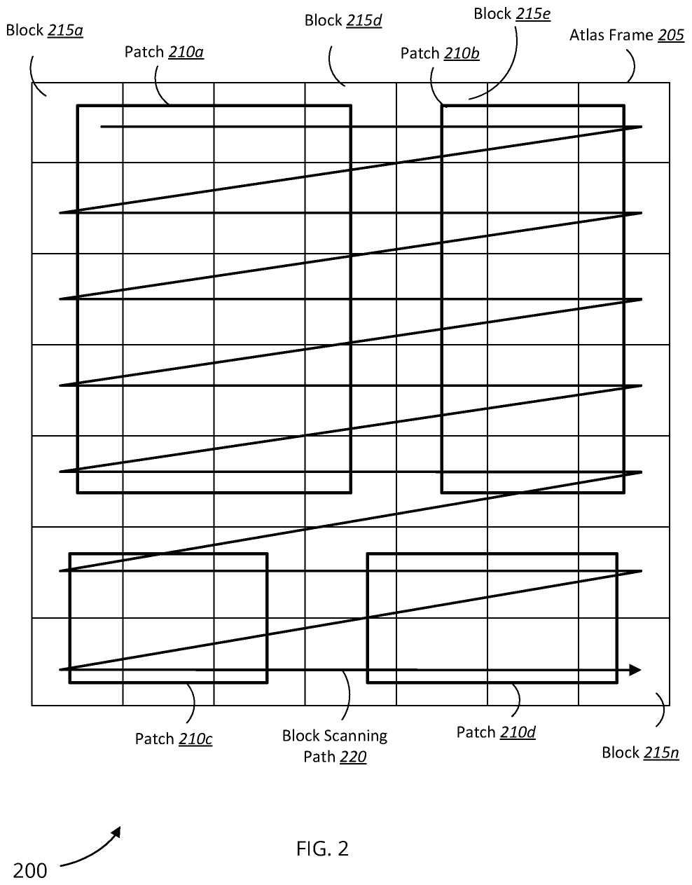

Thus, the output of the atlas pre-processing 140 may, in some embodiments, output a decoded atlas frame, per block, in a raster scan order. This is in contrast with typical output to an input buffer of the presentation engine 175 in a patch-based order. This is described in more detail with respect to FIGS. 2 & 3. Utilizing the above format, once the resolution of an image is known, the number of blocks in an image may also be known.

According to an alternative embodiment, the atlas pre-processing 140 may modify the decoded atlas bitstream to add identification information for elements in the decoded atlas bitstream. Identification information may include, without limitation, an atlas frame delimiter (e.g., an atlas frame start code), an atlas tile delimiter (e.g., an atlas tile start code), patch delimiter (e.g., atlas patch start code), followed by blocks in raster scan order (or in other examples, a scan order following a different space-filling curve). In yet further embodiments, each atlas frame may include an atlas frame size in bytes (32 bits) followed by the atlas frame payload. The atlas payload may include an indication of tile size in bytes (32 bits), followed by the tile payload. The tile payload may include an indication of patch size in bytes (32 bits) followed by the patch payload, which includes the blocks in a raster scan order. Each tile payload may include origin coordinates (e.g., x, y coordinates), each coordinate indicated by a 32-bit value, and size (in width and height), each indicated by a 32-bit value. Each patch may similarly include origin coordinates (x, y) indicated respectively by a 32-bit value, and patch size (width and height) indicated respectively by a 32-bit value. Each block may, as previously described, include occupancy map 2d array represented in a row-major raster scan order (e.g., 16 bits for a 4×4 array), and associated patch 3D information transmitted for each block, and patch 3D shift information in the tangential, bitangential, and normal axes for each block.

In yet further embodiments, a combination or sub-combination of the above formats may be employed by the atlas pre-processing 140. For example, the atlas pre-processing 140 may be configured to add to a decoded atlas frame bitstream one or more of: tile information; tile and/or patch identifiers; frame, tile, and/or patch delimiters; and frame, tile and/or patch size indicators, as described above. The atlas pre-processing 150 may, accordingly, output the pre-processed decoded atlas bitstream in a raster-scan block-order.

In various embodiments, the component processing 145 may similarly process decoded component bitstreams (e.g., occupancy, geometry, and attributes) into corresponding component images (e.g., component frames of associated patches). In some embodiments, the origins and sizes of the patches of the component images (e.g., frame) may correspond to patch origin and patch sizes of the atlas frame.

The outputs of the pre-processing logic 140, 145 may be provided to respective component buffers of the input buffer 150. Accordingly, in some embodiments, the input buffer 150 may include an atlas buffer 155 for storing the block-order decoded atlas bitstream, and respective occupancy, geometry, and attribute buffers 160, 165, 170 for storing the respective decoded component bitstreams (e.g., occupancy, geometry, and attribute decoded bitstreams), respectively.

The input buffer 150 may then be configured to provide the pre-processed component streams, and in this example, the block-order decoded atlas bitstream to the presentation engine 175 for rendering. In various embodiments, the immersive media data 105 may include component bitstreams that are encoded in an order that is independent from other component bitstreams. For example, the immersive media data 105 may include an encoded occupancy bitstream corresponding to frame 3, followed by frame 0, followed by frame 1, followed by frame 2. An atlas bitstream, however, may be encoded in a different order, for example, frame 0, frame 1, frame 2, frame 3. Thus, during decoding, the component bitstreams may be decoded in varying order. Thus, the pre-processing logic, including atlas pre-processing 140 and component pre-processing 145, and input buffers 150, may be used to synchronize the decoded bitstreams for presentation to the presentation engine. It is to be understood that the above order of frames is provided by way of explanation only, and is not intended to limit any specific embodiments.

In further embodiments, because each block comprises information required to render the individual block, the presentation 175 may be able to selectively render a desired patch, block, or entire tile.

FIG. 2 is a schematic diagram 200 of an atlas frame 205, in accordance with various embodiments. Specifically, the atlas frame 205 may include patches 210a-210d, a plurality of blocks 215a-215n, and block scanning path 220. In various embodiments, the atlas frame 205 may include one or more tiles, each tile comprising one or more patches 210a-210d. In the example depicted, the atlas frame may comprise a single tile, which includes four patches 210a-210d.

In a typical patch-order decoded atlas bit stream, the blocks of each of the patches are output in raster scan order. For example, the blocks of the first patch 210a would be output, followed by the blocks of a second patch 210b, followed by the blocks of the third patch 210c, and finally the blocks of the fourth patch 210d.

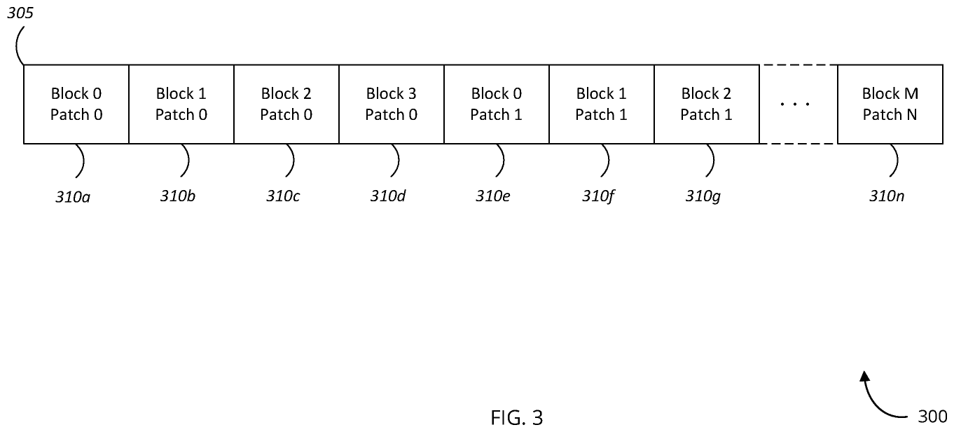

According to various embodiments, in contrast with the patch-order atlas frame, the blocks of a tile and/or atlas frame are output in raster scan order, as shown by the block scanning path 220. In this example, the blocks of the entire atlas frame 205 may be output in in raster scan order, regardless of the patch to which a given block 215a-215n belongs. Thus, the first block 215a through fourth block 215d of the first patch 210a may be followed by the first block 215e of the second patch 210b. In this way, the decoded atlas bitstream is output by an atlas component decoder to an atlas buffer, and further provided to the presentation engine in a block-based order (e.g., a block-order decoded atlas bitstream), as opposed to a patch-based order (e.g., patch-order). This is further illustrated with respect to FIG. 3.

In various embodiments, the size of the blocks 215a-215n may be determined based on a packing block size and an occupancy map resolution. In some examples, each block may have a resolution of 256 samples, where each block has a packing block size of 16 packing blocks, each packing block having a occupancy map resolution of 16 bits.

FIG. 3 is a schematic diagram 300 of a block-order atlas bitstream 305, in accordance with various embodiments. The block-order atlas bitstream 305 may include one or more sub-bitstreams 310a-310n corresponding to individual blocks of the atlas frame 205 illustrated in FIG. 2. The block-order atlas bitstream 305 may include a first sub-bitstream 310a through an n-th sub-bitstream 310n. The first sub-bitstream 310a may correspond to atlas information for a first block (block 0) of a first patch (patch 0). The n-th sub-bitstream 310n may correspond to atlas information for an M-th block of a N-th patch, wherein n, M, and N are integers. Continuing with the example of the atlas frame 205 of FIG. 2, the n-th sub-bitstream may be a 49th sub-bitstream corresponding to the last block of the atlas frame 205. The last block of the atlas frame 205 in this example may be an eighth block of a fourth patch.

As previously described, in various embodiments, each block (e.g., each sub-bitstream 310a-310n corresponding to a respective block), may be transmitted with one or more of: tile information; tile and/or patch identifiers; frame, tile, and/or patch delimiters; and frame, tile and/or patch size indicators, as previously described above.

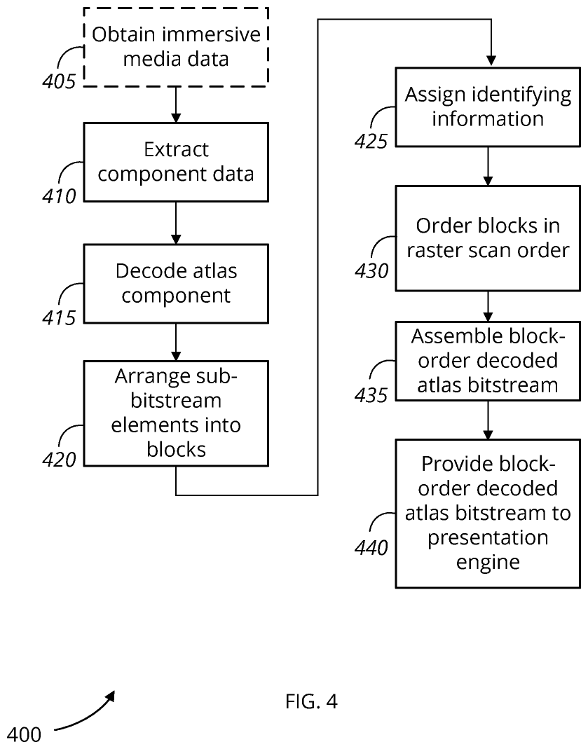

FIG. 4 is a flow diagram of a method 400 for provisioning decoded atlas information associated with volumetric content, in accordance with various embodiments. The method 400 begins, at block 405, by obtaining immersive media data. As previously described, in various embodiments, the immersive media data may include data for rendering 3D media. The immersive media data may be encoded data including one or more components for rendering 3D media.

The method 400 may continue, at block 410, by extracting the component data from the immersive media data. As previously described, in various embodiments, a demultiplexer may be utilized to extract an atlas component from the immersive media data, as well as an occupancy component, geometry component, and attribute component. In some further embodiments, static metadata from the immersive media data may also be extracted.

At block 415, the method 400 continues by decoding the atlas component extracted from the immersive media data. In various embodiments, an atlas component decoder may be configured to decode the encoded atlas component data. The atlas component decoder may be configured to output a decoded atlas bitstream. As previously described, the output of the atlas component decoder may be decoded atlas information in raw bytestream, indicating an inverse projection process from 2D into 3D space. The decoded atlas bitstream may include varying patches from one or more different frames. In some examples, the decoded atlas bitstream may include atlas information in a patch-order, for a given atlas tile. In further examples, the decoded bitstream may includeatlas information that is ordered hierarchically by atlas frame, atlas tile, and patch-order, as previously described.

At block 420, the method 400 continues by arranging sub-bitstream elements of the decoded atlas bitstream into blocks. Specifically, the size of a block may be determined by the packing block size and occupancy map resolution of an atlas/atlas frame. Once this is determined, the decoded atlas bitstream may be divided into sub-bitstreams corresponding to different blocks. For example, the decoded atlas bitstream may include atlas information for one or more patches. Each of the portions of the decoded atlas bitstream associated with a particular patch may be arranged into sub-bitstream elements corresponding to blocks of the patch.

The method 400 continues, at block 425, by assigning identifying information to the blocks. In various embodiments, atlas component pre-processing may be configured to assign identifying information to the blocks by adding header information to each block (or sub-bitstream) of the decoded atlas bitstream. As previously described, in some examples, identifying information may include tile information, such as a tileID, tile origin, and/or tile size. In further examples, identifying information may include tileID and patchID, which may be added to each block. In yet further embodiments, identifying information may include, without limitation, frame, tile, and/or patch delimiters, and frame, tile, and/or patch size indicators, as previously described.

The method 400 includes, at block 430, by ordering the blocks in raster scan order. In some examples, this may include ordering the blocks in a scan order following to a space-filling curve, such as raster scan order, for an entire atlas tile, irrespective of the patch to which the block belongs. For example, an atlas tile may include two adjacent patches, in which the blocks of a top row of the atlas tile may belong to the two adjacent patches. Thus, in the raster scan order for the atlas tile, starting from the top-left-most block, the blocks of the entire top row of the atlas tile may be output first, followed by the second row, and so on, in a block-order (e.g., raster scan order) first. This is in contrast with patch-order, in which blocks are output in a raster scan order within each sequential patch. Thus, in patch-order, the entire top row of the atlas tile would not be output in order, but rather each of the blocks of a patch would be output first, followed by the blocks of a subsequent patch. In further examples, the blocks may be ordered in a raster scan order for the entire atlas frame.

In further embodiments, the method 400 may include, at block 435, assembling a block-order decoded atlas bitstream. Thus, in various embodiments, the block-order decoded atlas bitstream may include a series of sub-bitstreams, corresponding to individual blocks in raster scan order, with each block including the added identifying information. In various embodiments, once arranged in block-order, the blocks of the block-order decoded atlas bitstream may be provided to a block buffer, which may further provide, at block 440, the block-order decoded atlas bitstream to a presentation engine.

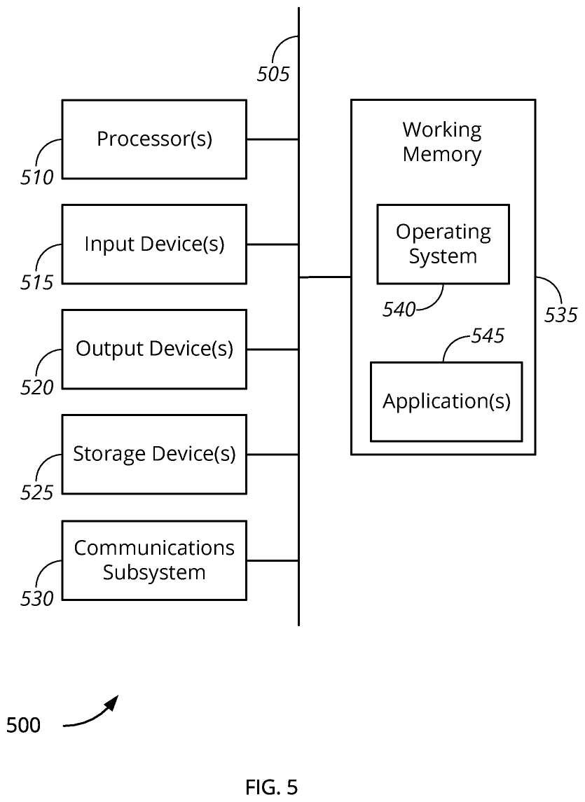

The techniques and processes described above with respect to various embodiments may be performed by one or more computer systems FIG. 5 is a schematic block diagram of a computer system 500 for provisioning decoded atlas information associated with volumetric content, in accordance with various embodiments. FIG. 5 provides a schematic illustration of one embodiment of a computer system 500, such as the system 100, or subsystems thereof, which may perform the methods provided by various other embodiments, as described herein. It should be noted that FIG. 5 only provides a generalized illustration of various components, of which one or more of each may be utilized as appropriate. FIG. 5, therefore, broadly illustrates how individual system elements may be implemented in a relatively separated or relatively more integrated manner.

The computer system 500 includes multiple hardware elements that may be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and microcontrollers); one or more input devices 515, which include, without limitation, a mouse, a keyboard, one or more sensors, and/or the like; and one or more output devices 520, which can include, without limitation, a display device, and/or the like.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 500 might also include a communications subsystem 530, which may include, without limitation, a modem, a network card (wireless or wired), an IR communication device, a wireless communication device and/or chipset (such as a Bluetooth™ device, an 802.11 device, a WiFi device, a WiMax device, a WWAN device, a Z-Wave device, a ZigBee device, cellular communication facilities, etc.), and/or a low-power wireless device. The communications subsystem 530 may permit data to be exchanged with a network (such as the network described below, to name one example), with other computer or hardware systems, between data centers or different cloud platforms, and/or with any other devices described herein. In many embodiments, the computer system 500 further comprises a working memory 535, which can include a RAM or ROM device, as described above.

The computer system 500 also may comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally receives the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a storage device 525 either before or after execution by the processor(s) 510.

While some features and aspects have been described with respect to the embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while some functionality is ascribed to one or more system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with or without some features for ease of description and to illustrate aspects of those embodiments, the various components and/or features described herein with respect to a particular embodiment can be substituted, added and/or subtracted from among other described embodiments, unless the context dictates otherwise. Consequently, although several embodiments are described above, it will be appreciated that the invention is intended to cover all modifications and equivalents within the scope of the following claims.

What is claimed is:

1. A method comprising:
obtaining immersive media data comprising encoded data for three-dimensional volumetric media content;
extracting, via a media pipeline, component data from the immersive media data, the component data comprising an atlas component, attribute component, geometry component, and occupancy component;
decoding, via an atlas component decoder, the atlas component, wherein a decoded atlas component is output as decoded atlas bitstream;
assembling an atlas frame in block-order based on the decoded atlas bitstream, wherein assembling the atlas frame in block-order further comprises:
arranging, via the atlas pre-processing logic, one or more sub-bitstreams of the decoded atlas bitstream into one or more blocks, respectively;
assigning, via the pre-processing logic, header information to each block of the one or more blocks, the header information indicating respective tile information for each block;
generating, via the atlas pre-processing logic, a block-order decoded atlas bitstream, wherein generating the block-order decoded atlas bitstream includes:
ordering, via the atlas pre-processing logic, the one or more blocks of the decoded atlas bitstream in a scan order following a space-filling curve; and
providing, via the atlas pre-processing logic, the block-order decoded atlas bitstream to an input buffer of a presentation engine, wherein the input buffer is configured to provide the block-order atlas bitstream to the presentation engine.

2. The method of claim 1, wherein in method further comprises:
obtaining, via atlas pre-processing logic, the decoded atlas bitstream from the atlas component decoder;
wherein the decoded atlas information is provided by the atlas component decoder in a patch-order.

3. The method of claim 1, wherein the space-filling curve is a Z-order curve such that the scan order is a raster scan order, wherein the one or more blocks of the block-order decoded atlas bitstream are ordered in raster scan order of an atlas tile of the atlas frame.

4. The method of claim 1, wherein the header information comprises a patch identifier and block identifier of each block, the patch identifier identifying a patch to which a respective block belongs, and the block identifier identifying a position of the respective block within the patch.

5. The method of claim 1, wherein the respective tile information comprises one or more of a tile index, tile identifier, tile origin, and tile size for a respective block.

6. The method of claim 1, wherein the header information comprises a tile identifier and patch identifier.

7. The method of claim 1, wherein the header information comprises one or more of an atlas frame delimiter, atlas tile delimiter, and patch delimiter.

8. The method of claim 1, wherein the decoded atlas bitstream comprises an atlas frame size indicator followed by an atlas frame payload, wherein the atlas frame payload comprises one or more tile size indicators, each tile size indicator followed by a respective tile payload, and each respective tile payload comprises one or more patch size indicators, each patch size indicator followed by a respective patch payload, wherein the patch payload comprises a plurality of blocks in a raster scan order.

9. An apparatus, comprising:
a non-transitory computer readable medium in communication with the processor, the non-transitory computer readable medium having encoded thereon a set of instructions executable by the processor to:
obtain immersive media data comprising encoded data for three-dimensional volumetric media content;
extract, via a media pipeline, component data from the immersive media data, the component data comprising an atlas component, attribute component, geometry component, and occupancy component;
decode, via an atlas component decoder, the atlas component, wherein a decoded atlas component is output as decoded atlas bitstream;
assemble an atlas frame in block-order based on the decoded atlas bitstream, wherein assembling the atlas frame in block-order further comprises:
arranging, via the atlas pre-processing logic, one or more sub-bitstreams of the decoded atlas bitstream into one or more blocks, respectively;
assigning, via the pre-processing logic, header information to each block of the one or more blocks, the header information indicating respective tile information for each block;
generating, via the atlas pre-processing logic, a block-order decoded atlas bitstream, wherein generating the block-order decoded atlas bitstream includes:
ordering, via the atlas pre-processing logic, the one or more blocks of the decoded atlas bitstream in a scan order following a space-filling curve; and
provide, via the atlas pre-processing logic, the block-order decoded atlas bitstream to an input buffer of a presentation engine, wherein the input buffer is configured to provide the block-order atlas bitstream to the presentation engine.

10. The apparatus of claim 9, wherein the set of instructions is further executable by the processor to:
obtain, via atlas pre-processing logic, the decoded atlas bitstream from the atlas component decoder;
wherein the decoded atlas information is provided by the atlas component decoder in a patch-order.

11. The apparatus of claim 9, wherein the space-filling curve is a Z-order curve such that the scan order is a raster scan order, wherein the one or more blocks of the block-order decoded atlas bitstream are ordered in raster scan order of an atlas tile of the atlas frame.

12. The apparatus of claim 9, wherein the header information comprises a patch identifier and block identifier of each block, the patch identifier identifying a patch to which a respective block belongs, and the block identifier identifying a position of the respective block within the patch.

13. The apparatus of claim 9, wherein the respective tile information comprises one or more of a tile index, tile identifier, tile origin, and tile size for a respective block.

14. The apparatus of claim 9, wherein the header information comprises a tile identifier and patch identifier.

15. The apparatus of claim 9, wherein the header information comprises one or more of an atlas frame delimiter, atlas tile delimiter, and patch delimiter.

16. The apparatus of claim 9, wherein the decoded atlas bitstream comprises an atlas frame size indicator followed by an atlas frame payload, wherein the atlas frame payload comprises one or more tile size indicators, each tile size indicator followed by a respective tile payload, and each respective tile payload comprises one or more patch size indicators, each patch size indicator followed by a respective patch payload, wherein the patch payload comprises a plurality of blocks in a raster scan order.

17. A system for provisioning decoded atlas information, the system comprising:
a demultiplexer configured to demultiplex immersive media data, wherein immersive media data comprises encoded data for three-dimensional volumetric media content, wherein demultiplexing the immersive media data includes extracting an atlas component;
an atlas component decoder coupled to the demultiplexer, the atlas component decoder configured to decode the atlas component, wherein a decoded atlas component is output as decoded atlas bitstream;
an atlas pre-processing subsystem coupled to the atlas component decoder, the atlas pre-processing subsystem comprising:
a processor; and
a non-transitory computer readable medium in communication with the processor, the non-transitory computer readable medium having encoded thereon a set of instructions executable by the processor to:
arrange one or more sub-bitstreams of the decoded atlas bitstream into one or more blocks;
assign header information to each block of the one or more blocks, the header information indicating respective tile information for each block; and
generate a block-order decoded atlas bitstream, wherein generating the block-order decoded atlas bitstream includes:
ordering the one or more blocks of the decoded atlas bitstream in a scan order following a space-filling curve.

18. The system of claim 17, wherein the header information comprises a patch identifier and block identifier of each block, the patch identifier identifying a patch to which a respective block belongs, and the block identifier identifying a position of the respective block within the patch.

19. The system of claim 17, wherein the respective tile information comprises one or more of a tile index, tile identifier, tile origin, and tile size for a respective block.

20. The system of claim 17, wherein the header information comprises a tile identifier and patch identifier.
